(19) United States
(12) Patent Application Publication
(10) Pub. No.: US 2019/0146847 A1
(43) Pub. Date: May 16, 2019

(54) DYNAMIC DISTRIBUTED RESOURCE MANAGEMENT

(71) Applicants: Patrick D. Gibson, Tualatin, OR (US); Robert A. Todd, Beaverton, OR (US)

(72) Inventors: Patrick D. Gibson, Tualatin, OR (US); Robert A. Todd, Beaverton, OR (US)

(73) Assignee: Mentor Graphics Corporation, Wilsonville, OR (US)

(21) Appl. No.: 15/873,827

(22) Filed: Jan. 17, 2018

Related U.S. Application Data
(60) Provisional application No. 62/584,509, filed on Nov. 10, 2017.

(51) Int. Cl. G06F 9/50

(52) U.S. Cl. CPC G06F 9/5044; G06F 2209/5011; G06F 2209/503; G06F 2209/5014; G06F 2209/508

(57) ABSTRACT

Methods and apparatus for dynamic distributed resource management as can be used in large-scale electronic design automation processes, are disclosed. In some examples of the disclosed technology, a method for dynamic remote resource allocation includes receiving a request for one or more remote resources, identifying one or more resources available to satisfy the request, initiating one or more separate processes for the respective available resources, preparing the respective resources for use as remote resources, by the one or more separate processes running in parallel, and as a given resource of the one or more available resources completes the preparation, allocating the given resource as a remote resource. In some examples, allocated resources are dynamically integrated into the processing of the job. In some examples, as a given resource of the one or more available resources is allocated, tasking the given resource with a portion of the job.

### CROSS-REFERENCE TO RELATED APPLICATIONS

This application claims the benefit of and priority to U.S. Provisional Patent Application No. 62/584,509, entitled “DYNAMIC DISTRIBUTED RESOURCE MANAGEMENT,” which application was filed on Nov. 10, 2017. The entire disclosure of the prior application(s) is incorporated herein by reference.

### SUMMARY

Methods, apparatus, and systems related to remote resource management are disclosed. Particular implementations relate to highly-parallelized dynamic resource allocation in a complex distributed computing environment. According to one method, a request is received for one or more remote resources. One or more resources are identified to satisfy the request. One or more separate processes are initiated for the respective one or more identified resources. The identified resources are prepared for use as remote resources by the one or more separate processes running in parallel. The identified resources are allocated as remote resources as the preparation for each identified resource is completed independently.

According to another method, a request is received for one or more remote resources from a host system processing a job. One or more resources are identified from a resource pool to satisfy the request. One or more separate processes are initiated for the respective one or more identified resources. The identified resources are prepared for use as remote resources by the one or more separate processes running in parallel. The identified resources are dynamically allocated as remote resources as the preparation for each identified resource is completed independently. The allocated resources are integrated into the processing of the job by the host system as each resource is allocated.

According to one system configuration, a resource pool can have available computing resources. A primary host can coordinate processing of a job and can be coupled to the resource pool. One or more remote resources can be coupled to the primary host and can process separate portions of the job as coordinated by the primary host. A resource management engine can be coupled to the resource pool and the primary host. The resource management engine can obtain computing resources from the resource pool, prepare the resources in parallel, and dynamically allocate the computing resources to the primary host for use in processing the job while the primary host continues in parallel to coordinate processing of the job.

The present disclosure also includes computing systems and tangible, non-transitory computer readable storage media configured to carry out, or including instructions for carrying out, an above-described method. As described herein, a variety of other features and aspects can be incorporated into the technologies as desired.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1A is a schematic diagram depicting a resource management engine in a distributed computing environment.

FIG. 1B is a schematic diagram depicting a resource management engine embedded in a distributed computing environment with additional resources.

FIG. 1C is a schematic diagram depicting a resource management engine embedded and distributed within a distributed computing environment with additional resources.

FIG. 2A is a schematic diagram depicting a distributed computing environment using remote compute servers.

FIG. 2B is a schematic diagram depicting a distributed computing environment using remote data servers.

FIG. 2C is a schematic diagram depicting a distributed computing environment using remote monitoring servers.

FIG. 3 is a schematic diagram depicting a distributed computing environment using multiple remote resources.

FIG. 4 is a state diagram for a lifecycle of a remote resource.

FIG. 5 is a flowchart illustrating a process for preparing, in parallel, resources for use.

FIG. 6 is a flowchart illustrating a process for obtaining additional resources in parallel to processing a job.

FIG. 7A is a diagram depicting dynamic resource allocation in a distributed computing environment.

FIG. 7B is a communication timing diagram illustrating dynamic resource allocation.

FIG. 8 is a diagram depicting several states of dynamic resource allocation in a distributed environment while processing an EDA job.

FIG. 9A is a flowchart illustrating a process for dynamic distributed resource management.

FIG. 9B is a flowchart illustrating another process for dynamic distributed resource management.

FIG. 9C is a diagram depicting a system configuration for dynamic distributed resource management.

FIG. 10 is a diagram of an example computing system in which described embodiments can be implemented.

FIG. 11 is an example cloud computing environment that can be used in conjunction with the technologies described herein.

### DETAILED DESCRIPTION

### General Considerations

This disclosure is set forth in the context of representative embodiments that are not intended to be limiting in any way.

As used in this application the singular forms “a,” “an,” and “the” include the plural forms unless the context clearly dictates otherwise. Additionally, the term “includes” means “comprises.” Further, the term “coupled” encompasses mechanical, electrical, magnetic, optical, as well as other practical ways of coupling or linking items together, and does not exclude the presence of intermediate elements between the coupled items. Furthermore, as used herein, the term “and/or” means any one item or combination of items in the phrase.

The systems, methods, and apparatus described herein should not be construed as being limiting in any way. Instead, this disclosure is directed toward all novel and non-obvious features and aspects of the various disclosed embodiments, alone and in various combinations and subcombinations with one another. The disclosed systems, methods, and apparatus are not limited to any specific aspect or feature or combinations thereof, nor do the disclosed things and methods require that any one or more specific advantages be present or problems be solved. Furthermore, any features or aspects of the disclosed embodiments can be used in various combinations and subcombinations with one another.

Although the operations of some of the disclosed methods are described in a particular, sequential order for convenient presentation, it should be understood that this manner of description encompasses rearrangement, unless a particular ordering is required by specific language set forth below. For example, operations described sequentially can in some cases be rearranged or performed concurrently. Moreover, for the sake of simplicity, the attached figures cannot show the various ways in which the disclosed things and methods can be used in conjunction with other things and methods. Additionally, the description sometimes uses terms like “produce,” “generate,” “display,” “receive,” “emit,” “verify,” “execute,” and “initiate” to describe the disclosed methods. These terms are high-level descriptions of the actual operations that are performed. The actual operations that correspond to these terms will vary depending on the particular implementation and are readily discernible by one of ordinary skill in the art.

Theories of operation, scientific principles, or other theoretical descriptions presented herein in reference to the apparatus or methods of this disclosure have been provided for the purposes of better understanding and are not intended to be limiting in scope. The apparatus and methods in the appended claims are not limited to those apparatus and methods that function in the manner described by such theories of operation.

Certain of the disclosed methods can be implemented using computer-executable instructions stored on one or more computer-readable media (e.g., computer-readable media, such as one or more optical media discs, volatile memory components (including random-access memory, such as dynamic RAM (DRAM), static RAM (SRAM), or embedded DRAM (eDRAM), or non-random access memories, such as certain configurations of registers, buffers, or queues), or nonvolatile memory components (such as flash drives and hard drives)) and executed on a computer (e.g., any commercially available computer, including smart phones or other mobile devices that include computing hardware). Any of the computer-executable instructions for implementing the disclosed techniques, as well as any data created and used during implementation of the disclosed embodiments, can be stored on one or more computer-readable media (e.g., computer-readable storage media). The computer-executable instructions can be part of, for example, a dedicated software application or a software application that is accessed or downloaded via a web browser or other software application (such as a remote computing application). Such software can be executed, for example, on a single local computer (e.g., with general-purpose or specialized processors executing on any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented with software written in C, C++, Java, or any other suitable programming language. Likewise, the disclosed technology is not limited to any particular computer or type of hardware. Certain details of suitable computers and hardware are well-known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

### Introduction to the Disclosed Technology

Certain examples of the disclosed technologies enable highly-parallelized, dynamic remote resource management in a distributed computing environment. This can be accomplished through a remote resource management engine, which can serve the purposes of connecting, initializing, and removing compute resources, data server resources, or network monitoring resources in an integrated manner in a distributed computing environment.

This requires the ability to monitor currently executing operations across all resources in the distributed computing environment to determine if adding or removing resources would be beneficial. The benefit to the user is that by dynamically adjusting the resources available to any computational process, we are able to allow for fair-share use of valuable resources and licenses.

The remote resource management engine can be employed during initial resource launch, such as at the start of a processing job, as well as in currently active environments for dynamic resources allocation, such as during a processing job. This engine allows for rapid remote resource addition and removal, which can reduce or minimize the expensive overhead of startup and shutdown, as well as overall processing time. Thus, users of a distributed computing environment using this engine are better able to maximize the use of available remote resources and to minimize turnaround time for highly compute-intensive processing jobs. The flexibility of this engine in distributed resource management enables remote resource usage into the hundreds of thousands of remote resources.

A variety of examples are provided herein to illustrate the disclosed technologies. The technologies from any example can be combined with the technologies described in any one or more of the other examples to achieve the scope and spirit of the disclosed technologies as embodied in the claims, beyond the explicit descriptions provided herein. Further, the components described within the examples herein can be combined or recombined as well, as understood by one skilled in the art, to achieve the scope and spirit of the claims. Additionally, each of the described features can be multithreaded or utilize hyperthreading; for example, a remote registry or a resource management engine can manage multiple threads.

### Example Processing Job

A processing job can include a set of operations for calculating a result, performing an analysis, or generating some other output, such as a data file. A job can include data for the operations and can indicate the output expected. Jobs can be highly complex, involving a large number of operations and large amounts of data. The operations can have varying dependencies between each other and the data, and can repeat use of data, or generate new data for further operations. A job can be supplied in a file, such as a binary file, or in multiple files. Operations and data can reside within the same job file(s) or be separated into separate files.

As an example, electronic design automation (EDA) often involves highly-complex processing jobs for designing electronic systems, such as integrated circuits or circuit boards. This can include functional verification or formal verification of the circuitry, and is often accomplished in a distributed computing environment because these tasks are generally computationally-intensive. An EDA job can include multiple layers, which can be related to the circuit design. An EDA job can come from a job submission system, such as LSF, Grid, or Openlava. A job submission system can be any suitable resource reservation system. In some examples, an EDA job comprises a processing job for physical verification of an integrated circuit, for example, a multi-core processor or system on chip.

### Dynamic Resource Architecture

FIG. lA illustrates an architecture 100 that can utilize dynamic remote resource distribution. A job manager 120 can manage multiple processing jobs, such as job 130, and the resources for the multiple processing jobs. The job manager 120 can have access to an external resource pool 110. The job manager 120 can obtain additional processing resources from the external resource pool 110 and provide the additional processing resources to a job 130. Additional processing resources from the job manager 120 can be made available in a job resource pool 131 for the job 130. The job resource pool 131 is accessible to a primary host 132 through a resource management engine 138. The resource management engine 138 can provide remote resources from the job resource pool 131 to the primary host 132 as needed or requested by the primary host. The resource management engine 138 can also communicate with the job manager 120 to set up a job 130, which can include obtaining resources for the job, or to request additional resources if the job resource pool 131 does not have sufficient resources to meet the requirements of the primary host 132. Alternatively, the primary host 132 can in part communicate with the job manager 120. This can be done at specific times or for specific functionality, such as when a job 130 is first initiated or when the primary host 132 is first set up.

The primary host 132 can have multiple secondary hosts, such as secondary host 1 134 through secondary host n 136. The primary host 132 can have multiple remote resources 133. The secondary hosts can also have remote resources separate from those of the primary host 132; secondary host 1 134 can have remote resources 135, and secondary hosts through secondary host n 136 can have other remote resources 137. The resource management engine 138 can maintain a remote registry of the remote resources currently being utilized within the job 130. Specifically, this can include the remote resources 133 for the primary host 132, and the remote resources 135, 137 for the secondary hosts 1 through n 134,136.

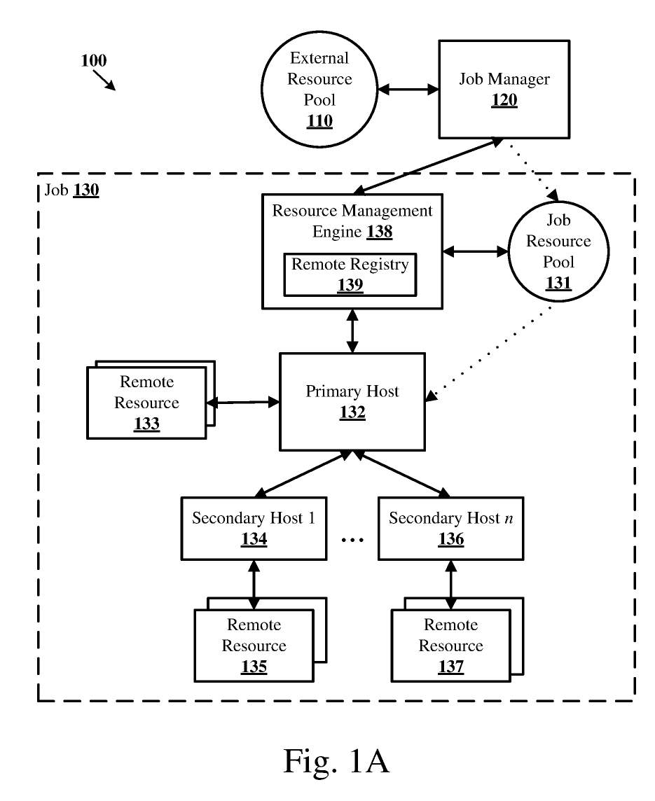

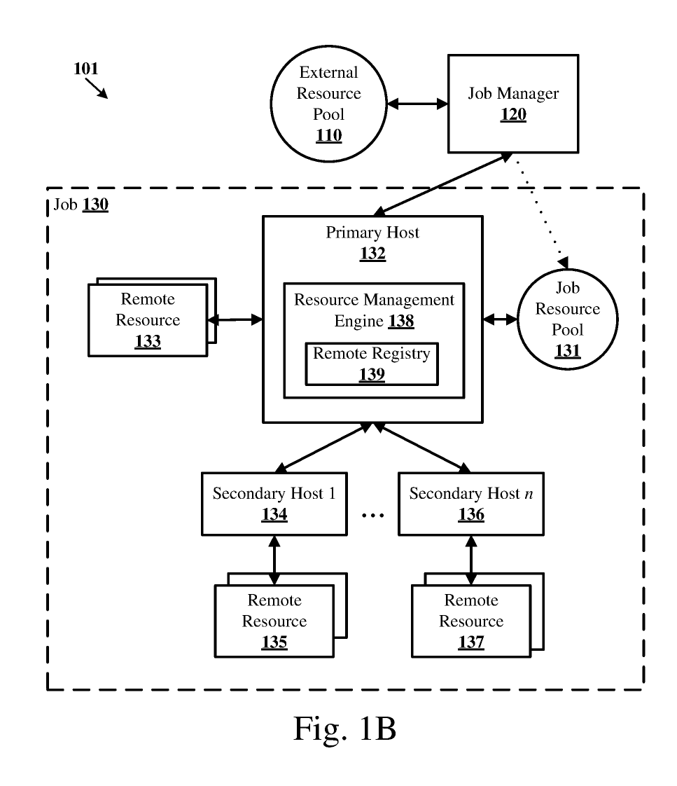

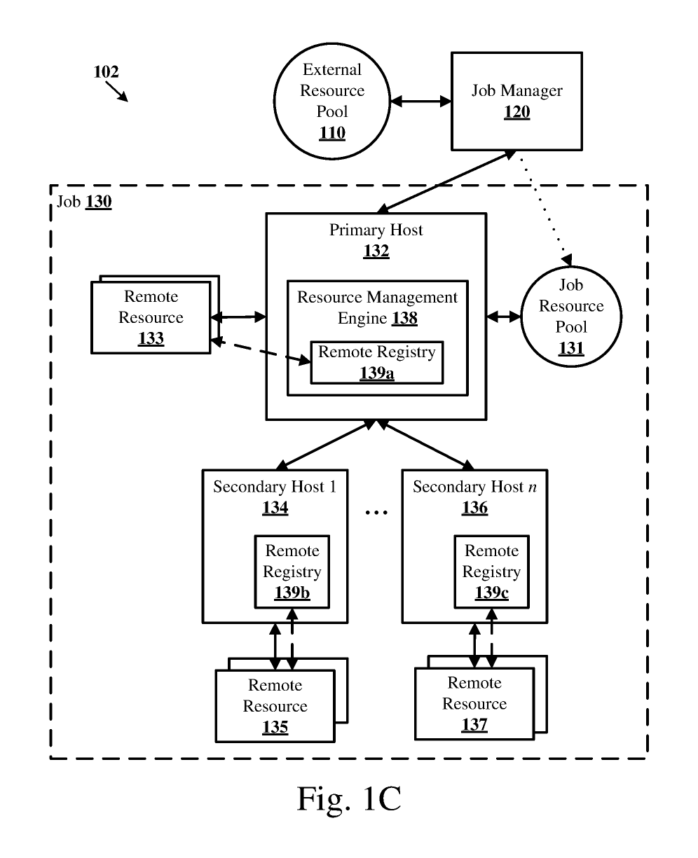

FIG. 1B illustrates an alternative configuration 101 of the architecture 100 from FIG. 1A. In architecture 101, a resource management engine 138, with a remote registry 139, can be embedded within a primary host 132. In this way, the functionality of the resource management engine 138 can be merged with the functionality of the primary host 132. In this embodiment, the primary host 132 performs the functionality of the resource management engine 138 by way of the embedded resource management engine. In another embodiment, the resource management engine 138 can be hosted or instantiated on the primary host 132, but still function separately from the primary host.

FIG. 1C illustrates an alternative configuration of the architecture 100 from FIG. lA and expands on the architecture 101 from FIG. 1B. In architecture 102, a resource management engine 138 is embedded within a primary host 132, as in the architecture 101 in FIG. 1B. The primary host 132 can have a remote registry 139a. The remote registry 139a can be embedded in the resources management engine 138 (as in FIGS. lA and 1B) or it can be separate from the resources management engine; the remote registry 139a can also be separate from the resource management engine 138 when the resource management engine is not embedded or integrated with the primary host 132. Further, the remote registry 139a in the resource management engine 138 is partially distributed to all the secondary hosts 1 through n 134, 136. In such an embodiment, each secondary host 1 through n 134, 136 can have a separate remote registry 139b, 139c for registering their separate remote resources 135, 137. For example, secondary host 1 134 can have a remote registry 139b in which the remote resources 135 of secondary host 1 are registered. This can be repeated for each secondary host 134, 136 of the primary host 132.

The primary host can have a remote registry 139a for registering remote resources. The remote registry 139a of the primary host 132 can register the remote resources 133 of the primary host. It can further also register the remote resources 135, 137 of the secondary hosts 1 through n 134, 136. This can be done in addition to the secondary host remote resources 135, 136 being registered at their secondary hosts' remote registries 139b, 139c.

### Example Primary Host

A primary host 132 can be a system for performing execution of a job 130 and can be initialized at the start of the job. Generally, a primary host 132 is responsible for a single job 130. The primary host 132 can perform some or all of the processing for the job 130, or it can coordinate processing of the job 130 between remote resources 133. Further, the primary host 132 can further coordinate the job 130 between multiple secondary hosts 134, 136 and their remote resources 135, 137. The primary host 132 can be responsible for allocating resource to execute the job, such as secondary hosts 134, 136 and remote resources 133, 135, 137. The primary host 132 can obtain resources from the job resource pool 131 or request additional resources from the job manager 120. The primary host 120 can direct such resources to be allocated as remote resources for itself 133, as secondary hosts 134, 136, or remote resources for the secondary hosts 135, 137. In general, the primary host 132 acts as a master system for the secondary hosts 134, 136.

The primary host 132 can be a computing system, such as a server, and can include a description of the operations and data for processing the job. The description of the operations and data for processing the job can be provided in a hierarchical database. The primary host 132 can include other software necessary to execute the job 130. The primary host 132 can partition the job 130 into multiple parts and provide each part to a secondary host 134, 136 to manage processing of that part. For example, an EDA job can come in layers, and each layer can be assigned to a secondary host for processing.

### Example Hierarchical Database

A hierarchical database can include multiple cells arranged into a hierarchy of layers. For example, the description of the operations and data for the processing of the job can be arranged into hierarchical cells in the hierarchical database, and the cells with the operations and data can be further arranged into hierarchical layers.

In one EDA scenario, each cell contains a portion of the hierarchical database. The data in the database is divided into hierarchical levels. The highest level contains only a single cell, while the second highest level may contain two or more cells, and so on. With this arrangement, a process (such as a simulation or verification process) using the input data in a higher level cell is generally not performed until its precedent cells (lower level cells) have been similarly processed. The same data may occur in multiple cells in multiple hierarchical levels. Thus, layout data, such as layout data relating to a specific structure like an electric contact, via, contact, interconnect, transistor, logic gate, or other component, may be repeatedly used in different hierarchical levels of the hierarchical database.

The hierarchy of the cells may be based upon a variety of different criteria. In another EDA scenario, the hierarchy of the cells may be arranged based at least in part upon the stacking order of individual layers of an integrated circuit in an EDA job. A portion of layout data for structures that occur in one layer of the integrated circuit thus may be assigned to a cell in a first hierarchical level. Another portion of the layout data corresponding to structures that occur in a higher layer of the integrated circuit may then be assigned to a cell in a second hierarchical level different from the first hierarchical level.

Alternately in this scenario, the hierarchy of the layout data may be based upon the combination of individual structures to form larger structures. For example, a portion of the layout data corresponding to an electrode contact may be assigned to a cell in a first hierarchical level. Another portion of the layout data corresponding to a NAND gate that includes the electrode contact may then be assigned to a cell in a second hierarchical level higher than the first hierarchical level. Still another portion of the layout data corresponding to a larger circuit structure employing a plurality of the NAND gates might then be assigned to a cell in a third hierarchical level higher than the second hierarchical level.

### Example Secondary Hosts

A secondary host 134, 136 can be similar to the primary host 132, but with a limited scope. A secondary host 134, 136 can be a computer system, such as a server, and can include a description detailing its portion of a processing job. The description can be provided as a hierarchical database. A secondary host 134, 136 can have only a portion of the job 130 and, as such, its scope can be limited to that portion of the job. For example, if the job 130 includes layers, a secondary host 134, 136 can have only one layer of the job to process. A secondary host 134, 136 can have software for processing its portion of the job 130. Such software can be the same as the primary host 132, or it can include additional specialized software for its specific portion of the job 130, or it can have different software.

A secondary host 134, 136 can act as a follower system to the leader system, primary host 132. A secondary host 134, 136 can have remote resources 135, 137 for executing its portion of the job 130. In some examples, a secondary host 134, 136 requests resources from the primary host 132, and the primary host obtains those resources on behalf of the secondary host 134, 136 and passes the requested resources to the secondary host 134, 136 from the job resource pool 131. Generally, secondary hosts 134, 136 do not communicate with other secondary hosts 134, 136 and process independently from other secondary hosts. Thus, the primary host 132 can coordinate processing between the secondary hosts 134, 136. In this way, secondary hosts 134, 136 function in parallel compared to the primary host 132.

A secondary host 134, 136 can be created or initialized by a job manager 120, such as at the start of a job 130, or it can be instantiated by the primary host 132, such as during the job when the primary host identifies that an additional secondary host would be beneficial.

### Example Remote Resources

A remote resource 133, 135, 137 can be a computer system, such as a server, that can provide needed functionality to another system, such as a primary host 132 or secondary host 134, 136. A remote resource 133, 135, 137 can be remote compute server (RCS), a remote data server (RDS), or a remote monitoring server (RMS), as further described herein. A remote resource 133, 135, 137 is generally allocated to a primary 132 or secondary host 134, 136 while functionality is needed, and can be released by the host once the functionality provided by the remote resource is no longer needed or deemed beneficial. Each remote resource 133, 135, 137 can have a unique remote ID, identifying the remote resource. In some examples, the remote ID cannot be reused during the processing of the job, even if the remote resource is removed, released, shutdown, or otherwise no longer in use. The lifecycle of a remote resource can begin when a new connection is established on a listening port of the remote resource and can end when the server socket for the remote resource is closed.

### Example Resource Management Engine

A resource management engine 138 can manage and maintain remote resources; this can include secondary hosts as well. The resource management engine 138 can contain or be integrated with a remote registry 139. In some examples, the remote registry 139 and the resource management engine 138 can be combined into one entity, which can be embedded or integrated with the primary host 132, for example.

The resource management engine 138 can communicate with a primary host 132. The resource management engine 138 can receive requests for additional resources from the primary host 132, or requests to release unneeded or underutilized remote resources from the primary host 132. The primary host 132 can route such requests from secondary hosts 134, 136 to the resource management engine. In another embodiment, the secondary hosts 134, 136 can communicate directly with the resource management engine 138.

The resource management engine 138 can access a job resource pool 131 to obtain additional resources as needed. If sufficient resources are unavailable in the job resource pool 131, the resource management engine 138 can communicate with a job manager 120 to obtain more resources from an external resource pool 110. The job manager 120 can add these resources to the job resource pool 131, which the resource management engine 138 can obtain and provide to a host system 132, 134, 136 as requested. Providing a remote resource can include providing an address or a remote ID for the remote resource. It can also include providing a port or socket for communication with the remote resource.

In some examples, the resource management engine 138 can handle resource management processing of remote resources, such as tracking, preparing, allocating or other procedural functions, and the remote registry 139 can handle resource management data, such as acting as a data store for information about the remote resources. In this way, the resource management engine 138 and the remote registry 139 can function together to manage remote resources in a distributed computing environment.

### Example Remote Registry

A resource management engine 138 can have a remote registry 139. The remote registry 139 can include a data file, database, or other accessible data storage system. The remote registry 139 can include a list of remote resources 133, 135, 137 allocated for use to process a job 130. The remote registry 139 can include a linked list of entries representing remote resources. The remote registry 139 can act as a master list to indicate if a remote resource 133, 135, 137 is available or unavailable for allocation. The remote registry 139 can be integrated with the resource management engine 138. In some examples, the remote registry 139 and the resource management engine 138 can be combined into one entity, which can be embedded or integrated with the primary host 132, for example.

A remote resource from the job resource pool 131 can be added to the remote registry 139 when a remote resource 133, 135, 137 is provided to a primary 132 or secondary host 134, 136 for use. The remote resource 133, 135, 137 can be removed from the remote registry 139 when the primary 132 or secondary host 134, 136 releases the remote resource. In this scenario, a remote resource 133, 135, 137 is tracked by being on the remote registry 139, but can be considered available if it is not on the remote registry 139.

The remote registry 139 can include read/write control functionality. For example, the remote registry 139 can include mutex functionality to ensure that the remote registry remains accurate and the same remote resource 133, 135, 137 is not added twice to separate hosts 132, 134, 136 or removed twice, or other mismatch scenarios.

In some examples, the remote registry 139 can include all remote resources available in the job resource pool 131. In this scenario, the remote registry 139 can indicate if the remote resource is available or allocated. It can also include an indication as to which host the remote resource is allocated. The remote registry 139 can include additional information useful to tracking or monitoring remote resources.

A remote registry can be divided into a distributed registry as shown in FIG. 1C. In this scenario, the primary host can have a remote registry 139a and the secondary hosts can each have a remote registry 139b, 139c. Thus, each host 132, 134, 136 can have a remote registry 139a, 139b, 139c; these remote registries can operate separately. The remote registry 139a at the primary host 132 can coordinate with the registries 139b, 139c at the secondary hosts 134, 136. For example, when a remote resource is added to the remote registry 139a at the primary host 132, that entry can be broadcast to the remote registries 139b, 139c at the secondary hosts 134, 136, and further mirrored at these registries. Similarly, when a remote resource is removed from the remote registry 139a at the primary host 132, the ID for the remote resource can be broadcast to the remote registries 139b, 139c at the secondary hosts 134, 136 and, if present, the entry for that remote resource can be removed.

The remote registries 139b, 139c at the secondary hosts generally only include remote resources allocated to that secondary host. The remote registry 139a at the primary host can only include remote resources 133 allocated to the primary host 132. In another embodiment, the remote registry 139a at the primary host 132 can include all remote resources 133, 135, 137, with the secondary host remote registries 139b, 139c containing the remote resources 135, 137 for their secondary hosts 134, 136. In this scenario, the remote registries at the secondary hosts 139b, 139c can act as partial backups to the remote registry 139a at the primary host 132.

In some examples, the remote registry 139a on the primary host 132 can be responsible for network monitor along with the primary host. Each host 132, 134, 136 can have a network monitor daemon, which can be launched when the first remote resource is provided to the host. When a last remote resource is removed from the host, the network daemon can be terminated. The network daemon can work in conjunction with the one or more RMSs for that host.

### Example Remote Compute Server

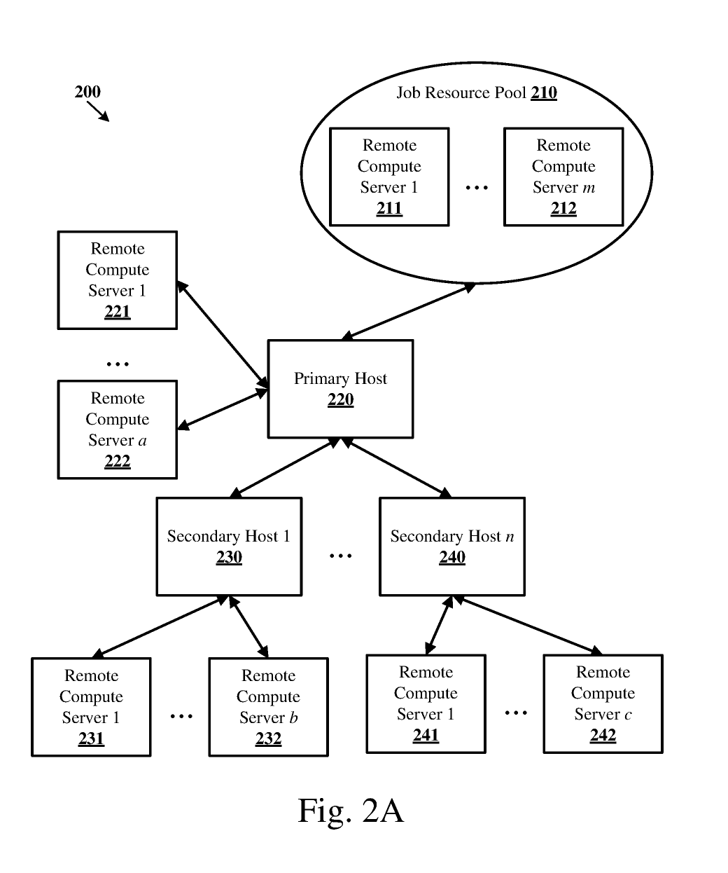

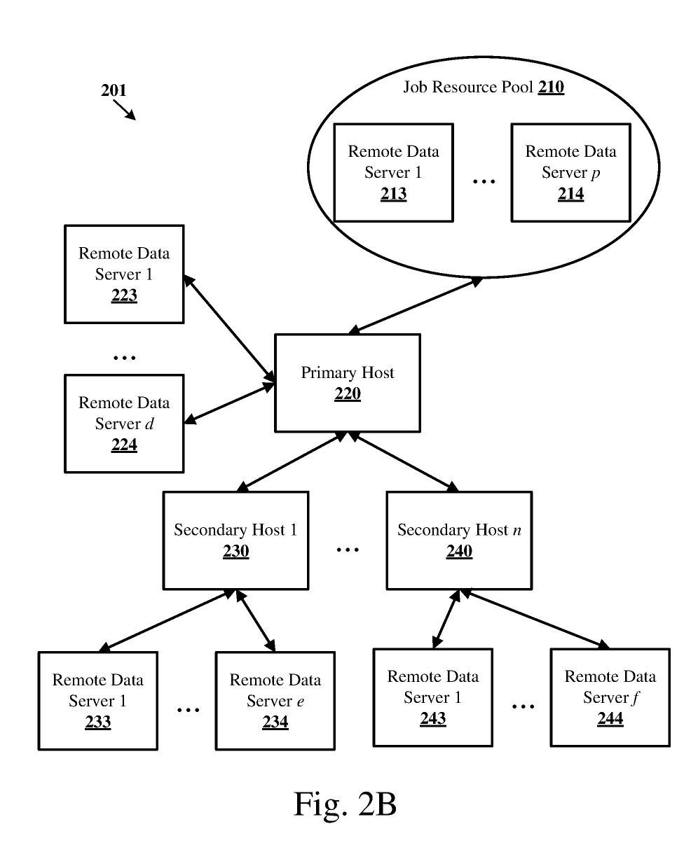

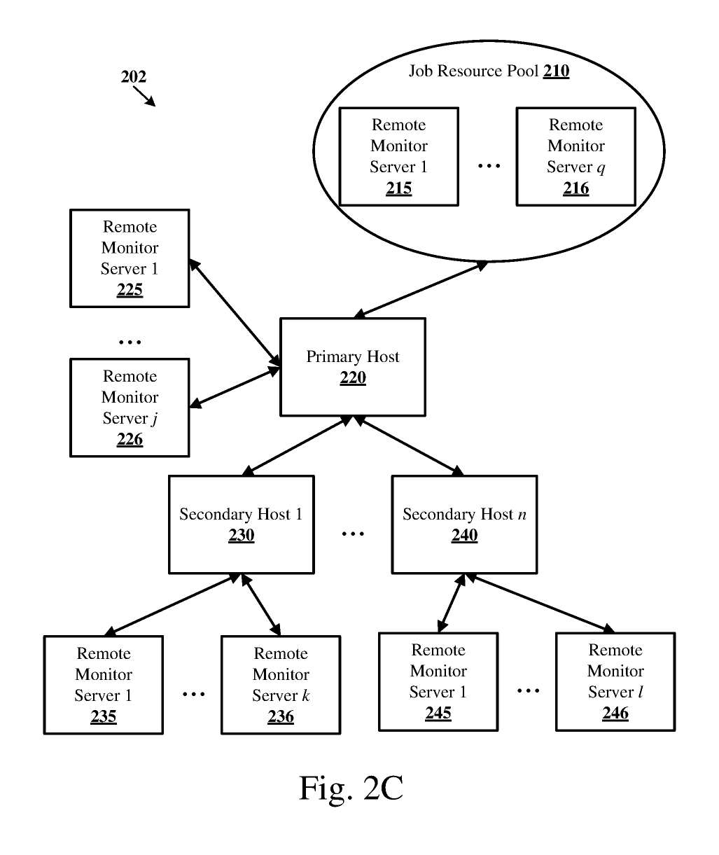

A remote resource can be a remote compute resource (RCS) as shown in FIG. 2A. An architecture 200 can be similar to the architectures 100, 101, 102 shown in FIGS. 1A-C for processing a job. A job resource pool 210 can have one or more available resources, such as a remote compute server 1 211 through a remote compute server m 212. The remote compute servers 1 through m 211, 212 can already be initialized or prepared as RCSs, or they can be generic remote resources that can be prepared to be RCSs.

A primary host 220 can access the job resource pool 210 to obtain additional RCSs 211, 212. The primary host 220 can access the job resource pool 210 directly, or it can access the job resource pool indirectly, such as through a resource management engine 138 in FIG. 1A. Accessing directly can include accessing through an embedded resource management engine, as shown in FIG. 1B.

A primary host 220 can have one or more secondary hosts, such as secondary host 1 230 through secondary host n 240. Each host can have one or more RCSs. Specifically, a primary host 220 can have remote compute server 1 221 through remote compute server a 222. A secondary host 1 230 can have a remote compute server 1 231 through remote compute server b 232. A further secondary host n can have a remote compute server 1 241 through a remote compute server c 242. Each host can have a different number of RCSs. Generally, each host does not share an RCS with another host. However, in some embodiments, an RCS can be shared between hosts.

An RCS can provide processing functionality to a primary or secondary host for use in executing a job. Generally, an RCS must be configured to be effective when used by a host. An RCS can receive some portion of a job from the primary or secondary host for processing. Generally, an RCS is allocated to a single host, however, in some embodiments, an RCS can be allocated to multiple hosts.

### Example Remote Data Server

A remote resource can be a remote data resource (RDS) as shown in FIG. 2B. An architecture 201 can be similar to the architectures 100, 101, 102 shown in FIGS. 1A-C for processing a job. A job resource pool 210 can have one or more available resources, such as a remote data server 1 213 through a remote compute server p 214. The remote data servers 1 through p 213, 214 can already be initialized or prepared as RDSs, or they can be generic remote resources that can be prepared to be RDSs.

A primary host 220 can access the job resource pool 210 to obtain additional RDSs 213, 214. The primary host 220 can access the job resource pool 210 directly, or it can access the job resource pool indirectly, such as through a resource management engine 138 in FIG. 1A. Accessing directly can include accessing through an embedded resource management engine, as shown in FIG. 1B.

A primary host 220 can have one or more secondary hosts, such as secondary host 1 230 through secondary host n 240. Each host can have one or more RDSs. Specifically, a primary host 220 can have remote data server 1 223 through remote data server d 224. A secondary host 1 230 can have a remote data server 1 233 through remote data server e 234. A further secondary host n can have a remote data server 1 243 through a remote data server f 244. Each host can have a different number of RDSs. Generally, each host does not share an RDS with another host. However, in some embodiments, an RDS can be shared between hosts.

An RDS can provide processing functionality to a primary or secondary host for use in executing a job. Generally, an RDS must be configured to be effective when used by a host. An RDS can store data for a job; this data can be data provided as part of the job initially, or be data generated during the processing of the job. Generally, an RDS is allocated to a single host, however, in some embodiments, an RDS can be allocated to multiple hosts. In some embodiments, an RDS (or several) is only allocated to a host when the host first is instantiated.

### Example Remote Monitoring Server

A remote resource can be a remote monitoring resource (RMS) as shown in FIG. 2C. An architecture 202 can be similar to the architectures 100, 101, 102 shown in FIGS. 1A-C for processing a job. A job resource pool 210 can have one or more available resources, such as a remote monitor server 1 215 through a remote monitor server q 216. The remote monitor servers 1 through q 215, 216 can already be initialized or prepared as RMSs, or they can be generic remote resources that can be prepared to be RMSs.

A primary host 220 can access the job resource pool 210 to obtain additional RMSs 215, 216. The primary host 220 can access the job resource pool 210 directly, or it can access the job resource pool indirectly, such as through a resource management engine 138 in FIG. 1A. Accessing directly can include accessing through an embedded resource management engine, as shown in FIG. 1B.

A primary host 220 can have one or more secondary hosts, such as secondary host 1 230 through secondary host n 240. Each host can have one or more RMSs. Specifically, a primary host 220 can have remote monitor server 1 225 through remote monitor server j 226. A secondary host 1 230 can have a remote monitor server 1 235 through remote monitor server k 236. A further secondary host n can have a remote monitor server 1 245 through a remote compute server 1 246. Each host can have a different number of RMSs. Generally, each host does not share an RMS with another host. However, in some embodiments, an RMS can be shared between hosts.

An RMS can provide network monitoring functionality to a primary or secondary host for use in executing a job. An RMS can monitor processing and communication between remote resources and the primary host or secondary hosts. Such monitoring is useful to determine when a remote resource is under-utilized or over-utilized, which aids in determining when additional resources can be needed or when a resource can be released (and so added back to the job resource pool). Generally, an RMS must be configured to be effective when used by a host. Generally, an RMS is allocated to a single host, however, in some embodiments, an RCS can be allocated to multiple hosts.

### Example Remote Resource Communication

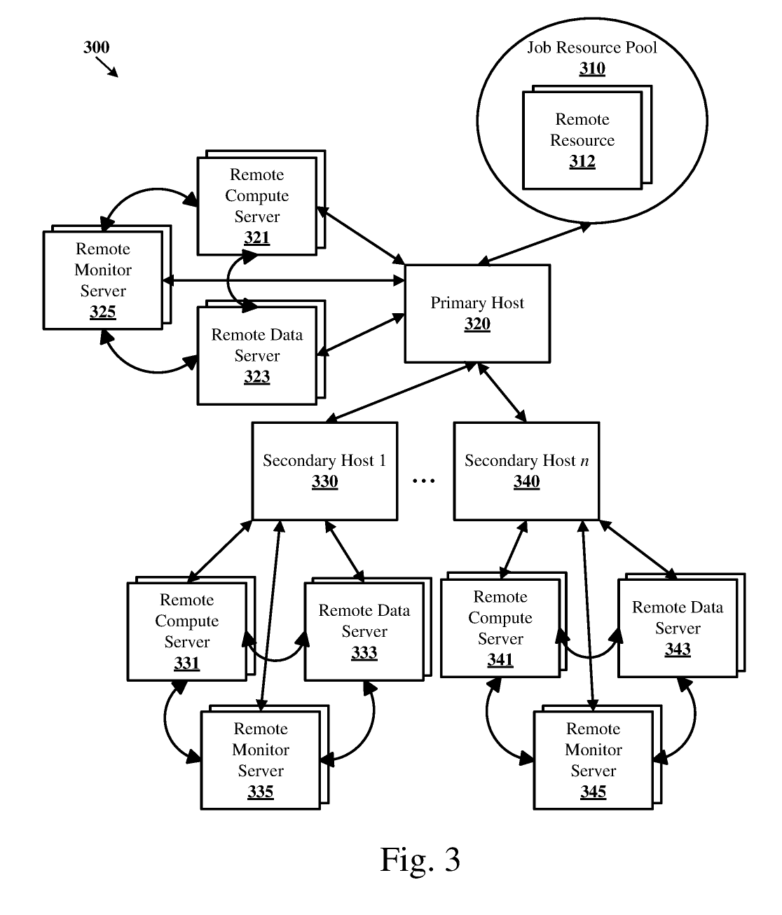

FIG. 3 depicts an architecture 300 for a distributed environment with dynamic remote resources and resource communication within the distributed environment. An architecture 300 can be similar to the architectures 100, 101, 102, 200, 201, 202 shown in FIGS. 1A-C and 2A-C for processing a job. A job resource pool 310 can have one or more available resources 312. These remote resources 312 can already be initialized or prepared, or they can be generic remote resources that can be prepared to be a remote resource as requested by a primary host 320, such as an RCS, RDS, or RMS.

A primary host 320 can have one or more secondary hosts, such as secondary host 1 330 through secondary host n 340. Each host can have one or more remote resources. Specifically, a primary host 220 can have one or more remote compute servers 321, one or more remote data servers 323, or one or more remote monitor servers 325. A secondary host 1 330 can have one or more remote compute servers 331, one or more remote data servers 333, or one or more remote monitor servers 335. A further secondary host n can have one or more remote compute servers 341, one or more remote data servers 343, or one or more remote monitor servers 345. Each host can have a different number of remote resources in general, and different numbers of specific remote resources, such as RCSs, RDSs, or RMSs. Generally, each host does not share remote resources. However, in some embodiments, remote resources can be shared between hosts.

The remote resources allocated to a host can intercommunicate. For example, the RCSs 321 of the primary host 320 can communicate with the RDSs 323 of the primary host. A primary host RDS 323 can contain data that is needed for processing being done by a primary host RCS 321, and so the RCS can obtain that data directly from the RDS. Alternatively, the RCS 321 can request the data from the primary host 320, which can direct the RCS to the appropriate RDS 323. In some examples, a remote registry as in FIGS. 1A-C can be used to establish connections between remote resources.

An RMS 325 can communicate with primary host RCSs 321 and RDSs 323 to monitor their workload or activity. By monitoring the remote resources 321, 323, an RMS 325 can identify when the remote resources have excess work and notify the primary host 320 that additional resources can be beneficial to processing the job. The RMS 325 can also identify when a remote resource 321, 323 have too little or no work, and can be released. Alternatively, an RMS 325 can provide data on remote resource capacity, or workload, or usage, to the primary host 320, which can then make the determination to request or release resources. Such a determination can be made by a remote resource management engine.

The remote resources for secondary hosts generally behave and communicate similarly as those for the primary host.

### Example Remote Resource Lifecycle

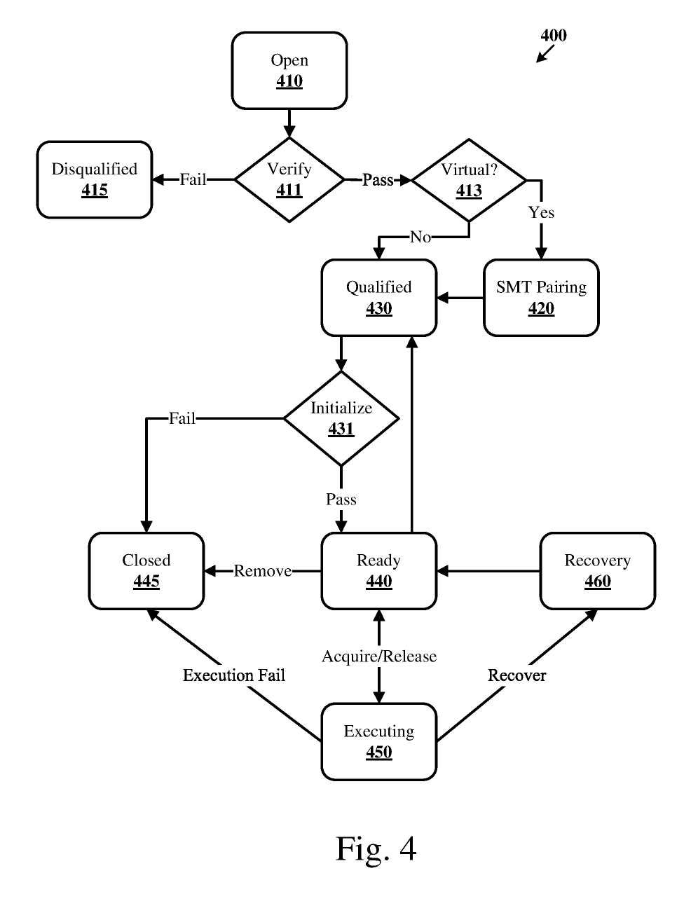

A remote resource can have a lifecycle that includes a set of statuses 400, as illustrated in FIG. 4. A status can define what stage a resource is at in its lifecycle, what can be done with the resource, or what changes can be made to a resource.

A resource begins at an open status 410. An open resource is currently not in use and generally can be found in a resource pool. An open resource is generally not ready for use in a distributed computing environment. To ensure that open resources are configured properly for use in a distributed computing environment, a series of preparation routines must be run to perform consistency checks as well as to initialize the resource for use within the distributed computing environment.

When an open resource is selected for use in the distributed computing environment, a consistency check is run to verify 411 the resource is functional. The consistency check can include ensuring the system can accept further changes to prepare the resource for use as a computing resource in the distributed environment. The consistency check can include checking compatibility with the master host. The consistency check can include analysis or comparison of software versions, or operating systems or operating system versions.

If the resource fails the verification 411, then the resource moves to the disqualified status 415. A disqualified resource is unsuitable in some way for use in the distributed computing system and can be removed from the resource pool. A disqualified resource can be recoverable, or can require intervention by a system administrator to repair the disqualified resource before returning it to an open status.

If the resource passes the verification 411, a check is performed to determine if the resource is a virtual resource or not 413. If the resource is a virtual resource, then the resource is paired with one or more threads or processes using simultaneous multithreading (SMT) 420. This pairing allows the virtual resource to have specific processes it uses to execute. In SMT (or hyperthreading), two virtual CPUs can share a single physical processor (or core). Reserving a single core in this scenario can reserve, allowing for the use of, both virtual CPUs sharing the single core. Remote resources can be created in pairs to utilize both virtual CPUs made available by reserving a single core using SMT. When resources are created in pairs in this scenario, they can be added as a pair to a remote registry, as described herein. Once paired, the resource moves to the qualified state 430.

If the resource is not a virtual resource, the verified open resource moves to the qualified status. A qualified resource is readily available for initialization and use in the distributed computing environment. A qualified resource can be immediately processed for use in the distributed computing environment, or it can wait as a qualified resource until a request for additional resources is made.

A qualified resource is initialized 431 to become usable in the distributed computing environment. Initialization 431 can include loading environmental software on the resource, or specialized software for processing within the distributed environment. Initialization 431 can also include loading global data for the distributed computing environment, such as global data for a processing job. Initialization 431 can further include providing a unique address or identifier for the resource for use within the distributed computing environment, or a means of communication with the resource, such as a port, a socket, or a shared memory location. If the resource successfully completes initialization 431, the resources moves to the ready status 440. If the resource does not successfully complete initialization 431, it moves to the closed status 445.

A ready resource is now fully available for use within the distributed computing environment. A ready resource can be acquired by a primary host, or allocated to a secondary host, for use in processing depending on the type of resource it was created to be, such as an RCS, RDS, or RMS. A resource acquired by a host enters the executing status 450. An executing resource 450 is processing according to the instructions and data provided to it by the host that acquired it. An executing resource 450 will continue to perform and function as a remote resource for the host that acquired it until the host releases it, or it encounters an error that demands further action. An executing resource 450 can be released by the host when the host no longer needs the functionality provided by the resource, and so the resource can be returned to a resource pool in the ready status 440.

An executing resource 450 can encounter a problem from which it can recover. In this scenario, the executing resource 450 will move to the recovery status 460. A recovering resource 460 will perform recover routines to clear the encountered problem, or can request assistance from another system, such as a host, to complete the recovery. Once the recovery is complete, the recovering resource 460 will return to the ready status 440.

An executing resource 450 can encounter a serious problem from which it cannot recover. In this scenario, the executing resource 450 will move to the closed status 445. A closed resource generally is not available for use within the distributed computing environment. A closed resource can be reset or cleared and returned to the open status 410, or it can require further intervention, such as a resource in the disqualified status 415.

A ready resource 440 can also be moved to the closed status 445, not through error, but by removal. A ready resource 440 can be removed and placed in the closed status 445 because the resource is not needed and can be made available elsewhere. For example, a ready resource 440 can remain in the ready status 440 without being acquired beyond a given length of time, which can indicate that additional resources are unlikely to be required, and so the ready resource 440 is removed to the closed status 445, where it can be provided to another system or otherwise used some other way. The closed status 445 can also be applied when a resource is shut down.

A ready resource 440 can also be moved to the qualified status 430, such as when new global data or other initialization routines must be applied. Then, the qualified resource 430 can be initialized again with the new data or routines, and be returned to the ready status 440.

### Example Remote Resource Preparation

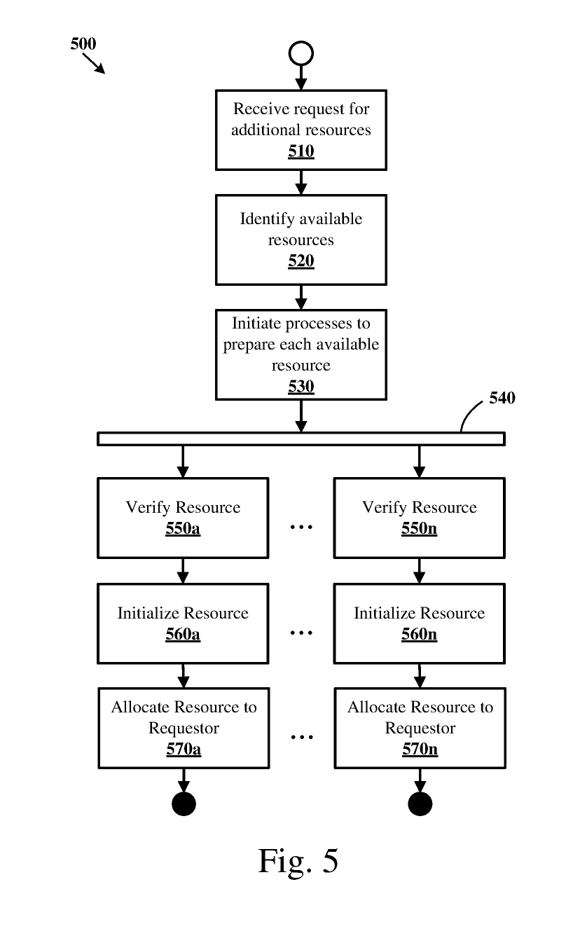

FIG. 5 illustrates a process 500 for preparing remote resources for use in a distributed computing environment. A request for additional resources is first received 510. The request can include a number of resources needed, or one or more types of resources needed, with a number of resources of each requested type. Types requested can include secondary host, RCS, RDS, or RMS. Generally, the request is received by the resource management engine. If the resource management engine is embedded or integrated into a primary host, then the request can be received by the primary host, or the portion of the primary host that is the resource management engine. In this scenario, the request can include identifying that additional resources are needed, and then identifying or obtaining available resources without making an explicit request to identify or obtain available resources.

If additional resources are needed, a remote registry can be checked for resources already available or ready for use. If ready resources are found on the remote registry that are not currently in use, or are underutilized, then those resources can be used. In this scenario, further requests for resources may not need to be made.

Next, available resources are identified 520, generally by a resources management engine. The resources management engine can identify available resources by checking a resource pool and obtaining the requested number of resources from the pool. In some examples, the resources in the resource pool are not yet prepared for use. If the resources obtained from the resource pool are prepared for use already, then the resources can be immediately provided to the requestor and the preparation process ended, or the preparation process can continue, overwriting any previous preparation of the resource.

The resource management engine can next initiate the preparation process 530 for the identified available resources. This can include creating or assigning a separate process (e.g. thread, system, or core) for each of the available resources to perform the preparation process. In this way, the preparation of each available resource can be accomplished in parallel 540.

Further, a script for preparing the resource can be loaded on each resource, such that each resource prepares itself by executing the script. These scripts can be loaded serially by the remote resource engine as part of initiating the preparation process 530, or can be loaded in parallel by the processes created to prepare the resources 530, 540.

The process 500 now follows the lifecycle of a remote resource for each of the resources in parallel 540, as described in FIG. 4. For each resource in parallel, the resource is verified 550a-n. Verification is similar to the verification in FIG. 4 at 411. If a resource passes verification 550a-n, the resource is next initialized 560a-n. Initialization is similar to the initialization in FIG. 4 at 431. If a resource is successfully initialized 560a-n, the resource is then allocated to the requestor 570a-n. Allocation can include notifying the requestor that the resource is available or providing identification or communication information to the requestor for the resource. Allocation can also include adding the resource to a remote registry, such as a general remote registry or a remote registry for the requestor. This can also include adding identification or communication information to the remote registry. Other information as described herein can also be added to the registry for the resource.

Once a resource is allocated to the requestor, the preparation process for that resource is complete. Because the resources are each being prepared separately and in parallel, this process can finish at varying times for each resource. The preparation of each resource in parallel generally will not affect the preparation of any other resource, including allocation and any use of the resource after allocation. A resource can be used immediately once allocated, including while other resources are still being prepared.

### Example Dynamic Allocation Overview

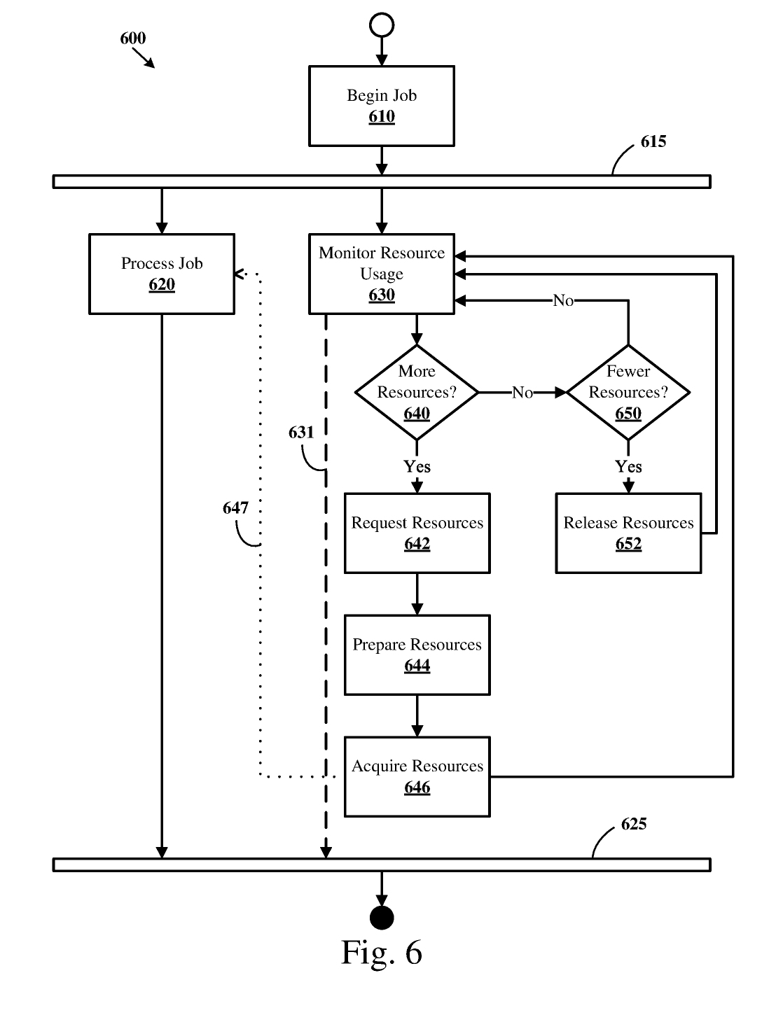

FIG. 6 illustrates a process 600 for obtaining remote resources for use in processing a job in a distributed computing environment. Processing a job is first started 610. Beginning the job can include setting up or initializing the distributed computing environment for processing the job, such as the environments or architectures described herein.

Once the job is started, the job is processed 620. Processing the job 620 can be accomplished by a primary host, which can use any remote resources allocated to the primary host. Processing the job 620 can further be accomplished by any secondary hosts of the primary host, which can use any remote resources allocated to the separate secondary hosts. Each of the hosts can process in parallel, and each of the remote resources for each of the hosts can also process in parallel, with the hosts coordinating between their remote resources and the primary host coordinating between the secondary hosts.

Processing the job is done in parallel 615 to monitoring resource usage within the distributed computing environment 630. Monitoring resource usage 630 can be accomplished by the primary host across all hosts and remote resources, or by each host monitoring its remote resources. Each secondary host can report monitoring information to the primary host. Further, the monitoring can be accomplished by one or more RMSs allocated to a host. An RMS can perform all monitoring 630, or can perform monitoring in conjunction with its host system. RMSs can function in parallel when monitoring, as each host or remote resource functions independently or in parallel.

Monitoring 630 can include identifying the workload of a system, such as number of operations assigned to the resource, or queued at the resource, or time spent performing operations, or time estimated to perform assigned or queued operations. Monitoring 630 can also include identifying memory usage. Monitoring 630 can include monitoring bandwidth usage between systems, such as remote resources or host systems, or other such network monitoring.

Monitoring resource usage 630 can also include identifying when additional resources are needed 640 or when currently allocated resources are not needed 650. More resources 640 can be needed when estimated process time exceeds a given expectation or threshold, or a resource is at a given percentage of capacity. Efficient processing 620 can be possible with fewer resources 650 when a resource is idle, has an estimated processing time below a given expectation or threshold, or is below a certain percentage of capacity. Other metrics or analysis can be used to determine if resources should be added or can be removed. The determination to change the number of allocated resources is shown in FIG. 4 640, 650 as a stepwise check for clarity, however, the determination need not be separate checks or be done in the shown order; the determination to change the number of resources allocated can be done as a single analysis or set of analyses.

If no change in resources is needed, such as a no more resources are needed 640 and fewer resources would not be effective 650, then monitoring resource usage continues.

If fewer resources 650 would be effective, then one or more underutilized resources can be released 652. Any resource that is currently in the ready state can be removed 652 immediately (synchronous execution). If more resources are to be removed than are currently in the ready state, the resources can be removed as they become idle (asynchronous execution); a remote registry can maintain a count of a number of resources to remove that are not yet removed.

Releasing a resource 652 can include returning the resource to the resource pool. Releasing a resource 652 can include removing the resource from the remote registry. Releasing a resource 652 can also include re-assigning any tasks or data remaining uncompleted on the resource to another resource that is not being released. Releasing a resource 652 can also include clearing the resource of data or tasks it had when processing the job, or resetting the resource, such that the resource requires complete preparation if re-allocated.

Once the underutilized resources are released 652, the process returns to monitoring resource usage 630. In some examples, the release of resources 652 is done in parallel to the monitoring of resource usage 630.

If it is determined that additional resources are needed 640, then additional resources are requested 642. The request can include a number of resources needed. The request can include one or more types of resources needed, such as a secondary host or RMS, and a number of resources of each type that are needed. The request can be made by a primary host, or a secondary host, or a remote resource designated to request resources, such as an RMS. The request can be made to the resource management engine, the primary host, or a resource pool.

Once a request for additional resources is made 642, the additional resources are prepared 644. Preparation of resources 644 generally follows the process 500 illustrated in FIG. 5 and described further in the example Remote Resource Preparation, above. The preparation of resources 644 can be done in parallel to the monitoring of resource usage 630.

Once additional resources are prepared and allocated 644, the resources can be acquired 646. The resources can be acquired 646 by the requesting system, such as the primary host or a secondary host, or can be acquired by the primary host and distributed to a requesting secondary host. In some examples, acquiring a resource 646 can be accomplished by putting the resource on the remote registry of that host, similar to allocating. In another embodiment, acquiring a resource 646 can be accomplished by indicating use by the acquiring system on the remote registry. Acquiring 646 can include integrating the resource 647 into the processing of the job 620, which can include assigning a portion of the job to the resource. Acquiring 646 can include configuring a resource to perform specific operations or tasks needed as part of processing the portion of the job assigned to the resource; configuring can include providing specific operations or data for processing, or providing specific software or access to other resources (which can include providing communication or identification information for the other resources, such as port or socket information, or shared memory locations).

Allocating and acquiring resources 644 for processing the job 620 is done in parallel to the processing of the job. The job processing 620 continues while the resources are dynamically allocated and acquired 646 to process the job, and integrated 647 into the job processing. Because resources are dynamically allocated and acquired, the hosts and remote resources already in use can continue processing the job without being stopped and restarted.

Once the resources are acquired 646, monitoring resource usage 630 can resume. In some examples, acquiring resources 646 can be done in parallel to monitoring resource usage 630.

When processing the job 620 is completed, monitoring resource usage can also complete 631. At this time, the parallel processing completes 625 and the process ends. Thus, monitoring resource usage 630, requesting additional resources 642 as needed 640 or releasing underutilized resources 652 as possible 650, preparing additional resources 644, and acquiring 646 and integrating 647 resources into the job processing 620 occurs in parallel to the job processing and continues while the job processing continues. When processing the job 620 completes, any uncompleted steps as shown can also be terminated. Any resources used by the job processing 620 can be released into the job resource pool (local pool) or can be released into an external resource pool (e.g. external to the job).

### Example Dynamic Resource Allocation Architecture

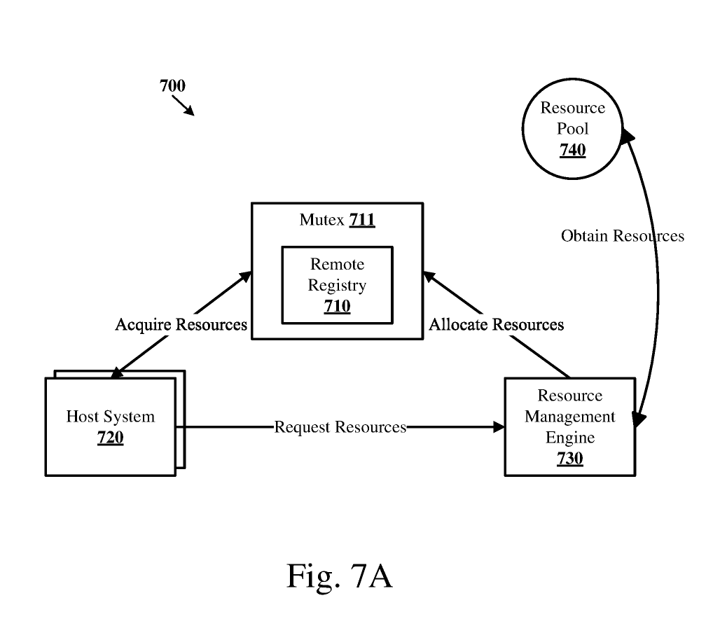

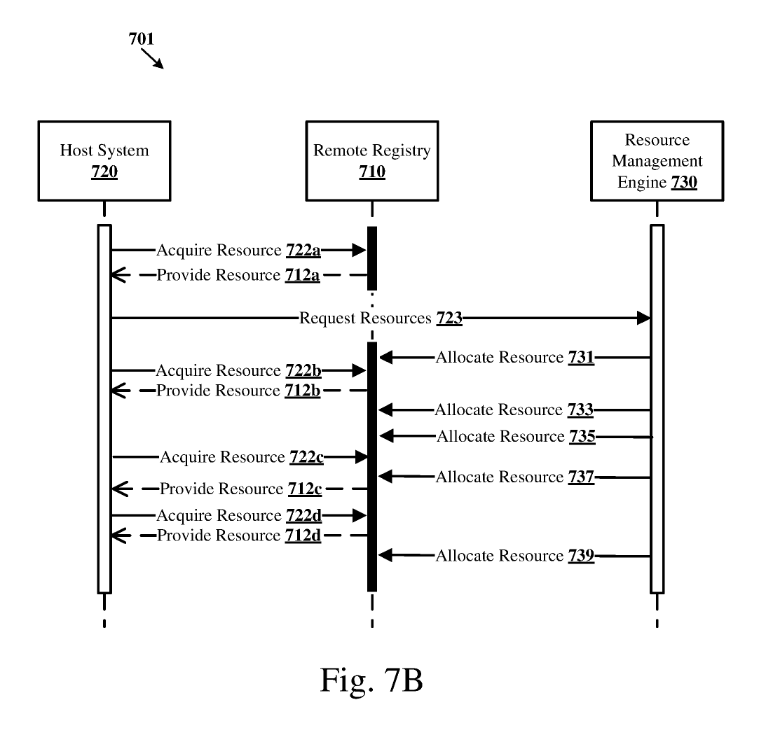

FIG. 7A is a diagram 700 illustrating dynamic resource allocation in a distributed computing environment. A remote registry 710 can maintain a list of remote resources ready for use in processing a job. The remote registry 710 can include information identifying each remote resource, or communication information for each resource, or other information useful for tracking the usage of the remote resource.

The remote registry can be accessed by a host system 720, such as a primary host or a secondary host. In some examples, the remote registry 710 can be available to multiple host systems in a distributed computing environment, such as the primary host and all or some of the secondary hosts, or some of the secondary hosts. In another embodiment, the remote registry 710 can be specific to an individual host. In this scenario, the distributed computing environment can have multiple remote registries.

A host system 720 can access the remote registry 710 to acquire resources, such as remote resources, for use in processing. Acquiring a resource can include obtaining communication information for the resources. Acquiring can further include integrating the resource into processing the job in parallel with other resources, such as communicating with the resource to assign operations or tasks for processing some portion of a job. Acquiring can include updating the remote registry 710 to include information indicating that the acquired resource is now in use, or which host system is using the resources, or other information about the status of the resource.

If the remote registry 710 has insufficient available resources allocated, the host system 720 can request additional resources from the resource management engine 730. The resource management engine 730 can obtain additional resources from a resource pool 740. The resources can then be prepared for use and allocated to the remote registry 710. In another embodiment, the host system 720 can request additional resources when the number of available resources on the remote registry 710 falls below a threshold.

The remote registry 710 can be accessed by a resource management engine 730. The resource management engine 730 can allocate resources to a host system 720 by adding the resources to the remote registry 710. Generally, a resource is prepared and ready for use by a host system 720 when it is allocated and placed on the remote registry 710. For example, the resource generally will be in the ready state as shown in FIG. 4 and described further in the example Remote Resource Lifecycle, above.

In some examples, each resource can prepare itself. In this scenario, each resource can add itself to the remote registry 710 once it completes preparation. Alternatively, the resource management engine 730 can add the resources to the remote registry 710 while the resources are preparing themselves (i.e. in parallel), or the resource management engine can wait until each resource notifies the resource management engine that it is prepared and then the resource management engine adds the resource to the remote registry (which can also be accomplished in parallel by separate processes).

The host system 720 and the resource management engine 730 can act in parallel, as either separate systems or as separate processes within the same integrated system. The requesting, allocation, and acquisition of resources is done dynamically, in parallel to the processing of a job by the host system 720 and any remote resources already acquired by the host system. Thus, resources can be dynamically allocated and, separately, dynamically acquired.

To protect against potential problems arising from dynamic access to the remote registry 710, access to the remote registry can be controlled by a mutex 711. The mutex 711 can act as a synchronization mechanism. The mutex 711 ensures that while multiple systems 720, 730 access the registry 710 in parallel, they do not do so simultaneously or in an incorrect order. This can protect the registry 710 from mismatched data based on partial writes from different systems, or from incomplete updates to the registry 710. The mutex 711 can protect the entire registry 710, or one or more specific portions of the registry, such as specific entries or fields of an entry. The mutex 711 can allow reads while enforcing write control access, or can control both reads and writes to the registry 710. In some examples, the resource management engine 730 and the remote registry 710 can be combined or integrated together. This can include the mutex 711 that manages access to the remote registry 710. The remote registry 710 can be a data file, database, or other accessible data storage system.

### Example Dynamic Resource Allocation Timing

FIG. 7B is a communication diagram 701 illustrating dynamic resource allocation in a distributed computing environment. The host system 720 can acquire a resource 722a from the remote registry 710. The remote registry 710 provides the resource 712a. Providing the resource 712a -d can include actively returning a remote resource listed in the remote registry 710. Alternatively, providing the resource 712a -d can include containing information about a remote resource listed and making the information accessible by the host system 720.

The host system 720 can request additional resources 723 from the resource management engine 730. This request 723 can be prompted if insufficient resources are available at the remote registry 710. The request 723 can also be prompted if the amount of resources available at the remote registry 710 falls below a threshold.

The resource management engine 730 can allocate additional resources 731, 733, 735, 737, 739 to the host system 720 by adding them to the remote registry 710. Allocating additional resources 731, 733, 735, 737, 739 is generally done in response to a request for additional resources 723. Resources can be obtained and prepared for use before being allocated. The resource management engine 730 will generally allocate the number of resources requested in the resource request 723.

As additional resources are allocated 731, the host system 720 can acquire the resources 722b, 712b. Allocating resources and acquiring resources can be done independently. A resource will be allocated 731 once it is ready, without waiting for additional resources that can have been requested to also be ready. Once a resource is allocated, it can be acquired.

For example, a resource request 723 can indicate a need for five additional resources. Once the first resource to satisfy this resource request 723 is ready, it can be allocated 731. This first resource can be acquired 722b, 712b by the host system 720 before a second resource is allocated 733. The second resource can be allocated 733, and then a third resource allocated 735, before the host system 720 acquires the next resource it needs 722c. A fourth resource can be allocated 737 after the host system 720 sought to acquire a resource 722c, but before the resource was provided 712c. The host system can acquire another resource 722d, 712d and then the resource management engine 730 can allocate the fifth resource 739. This can continue on similarly as described, while the host system continues processing a job.

### Example Dynamic Resource Allocation in an EDA Job

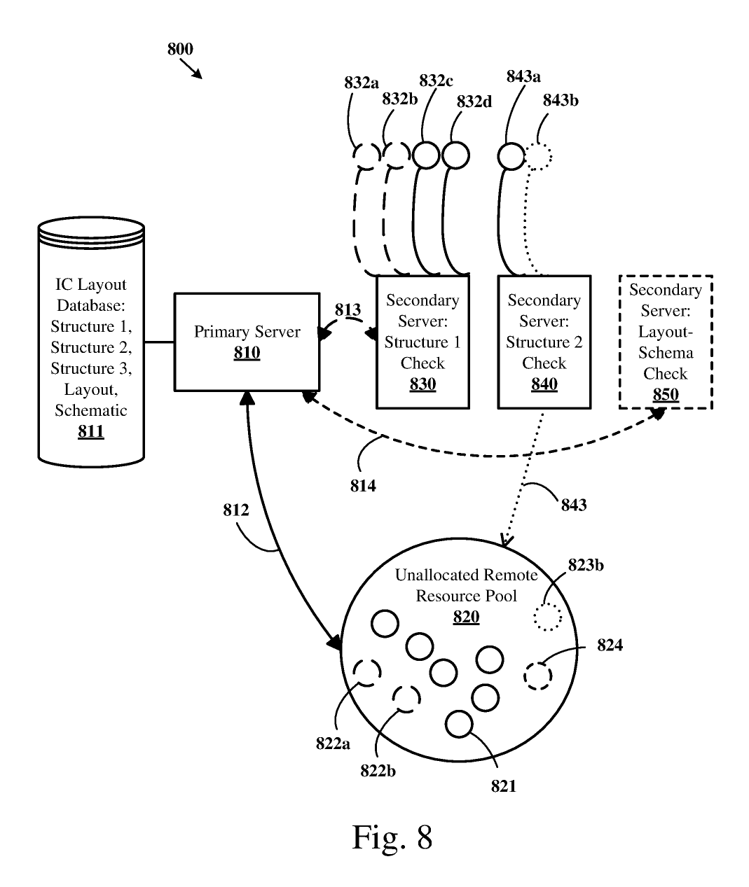

FIG. 8 is a diagram 800 illustrating dynamic resource allocation in a distributed computing environment for an EDA job. A primary server 810 can be used to coordinate an EDA processing job for an integrated circuit. The primary server 810 can be coupled to a database 811 that contains the integrated circuit layout. For example, the database 811 can be a GDSII or OASIS file. The database 811 can contain data describing integrated circuit structures, which may be represented in multiple layers of the database, for example, metal1-meta19, via1-via9, polysilicon, well, etc. The database 811 can also contain schematic data (e.g., expressed as SystemVerilog, Verilog, or Spice-format netlist files) and other design data for the integrated circuit design. The database 811 can be separate but accessible by the primary server 810, integrated with the primary server, or can be a file on the primary server.

The job can include verification or validation of the separate structures on the integrated circuit and of the layout of the integrated circuit compared to the schematic. The primary server 810 can partition the job across several secondary servers 830, 840, 850. For example, the primary server 810 can direct a secondary server 830 to perform the check of the first structure, such as vial with layers metall and metal2. The primary server 810 can simultaneously direct a different secondary server 840 to perform the check of the second structure, such as via2 with layers metal2 and metal3. The primary server 810 can perform the check of the third structure, such as antenna rule checks with device layers and one or more layers of interconnect (metal and via layers), or it can wait for another secondary server to become available to perform the check of the third structure, or it can instantiate a new secondary server to perform the check of the third structure. The secondary servers can function in parallel.

The secondary servers 830, 840, 850 can have remote resources 832a, 832b, 832c, 832d, 843a, 843b allocated to them for use in performing their respective portions of the EDA job. The remote resources can function in parallel. These remote resources can be RCSs, RDSs, or RMSs, as described herein.

The primary server 810 can have access to a pool 820 of unallocated remote resources 821. In some examples, the pool 820 can be accessed through a remote registry, as disclosed herein. The remote resources 821 can be in the Qualified or Ready state, as described in FIG. 4. The remote resources 821 in the resource pool 820 can be accessed by the primary server 810 for use in processing the EDA job. The unallocated remote resources 821 can be allocated as a new secondary server 850 or as remote resources 832a, 832b, 832c, 832d, 843a, 843b for the primary or secondary servers.

While processing a check on vial, the secondary server 830 may require additional remote resources beyond the remote resources it currently has 832c, 832d. The primary server can obtain 812 remote resources for use by a secondary server 822a, 822b from the resource pool 820. Once the primary server has obtained the unallocated remote resources 822a, 822b, it can allocated 813 the remote resources to a secondary server 830. The unallocated remote resources 822a, 822b are now allocated remote resources 832a, 832b of the secondary server 830; these new remote resources 832a, 832b can be in addition to remote resource 832c 832d that the secondary server already had. The secondary server 830 can use the new remote resources 832a, 832b for processing its portion of the EDA job. This process can be accomplished without the primary or secondary server pausing or halting the ongoing processing of the EDA job, as described herein. For example, the secondary server 830 can be processing its check of vial while it requests additional resources from the primary server 810, and then receives the additional resources 832a, 832b, incorporating these resources into the check of vial.

While processing a check on via2, the secondary server 840 may not need all the remote resources it has 843a, 843b. A secondary server 840 can release 843 a remote resources 843b that is already allocated to it. The secondary server can release a resource when it determines that the resource is under-utilized or otherwise unnecessary. A remote resource 843b, when released 843, can be returned to the unallocated resource pool 820 as another unallocated remote resource 823b. The secondary server can release one or more resources 843b while retaining other resources 843a. This process can be accomplished without the primary or secondary server pausing or halting the ongoing processing of the EDA job, as described herein. For example, the secondary server 840 can be processing its check of via2 while it releases a resource 843b back to the resource pool 820.

While processing the EDA job, the primary server 810 may require additional secondary servers beyond the secondary servers it currently has 830, 840. The primary server can obtain 812 a remote resource to become a secondary server 824 from the resource pool 820. Once the primary server 810 obtains the unallocated remote resource 824 from the resource pool 820, it can instantiate 814 the remote resource as a secondary server 850. This new secondary server 850 can be used to process a portion of the EDA job. For example, the new secondary server 850 can be provided the task of validating the integrated circuit layout against the schema. This process can be accomplished without the primary server pausing or halting the ongoing processing of the EDA job, as described herein.

### Example Methods and System for Dynamic Resource Allocation

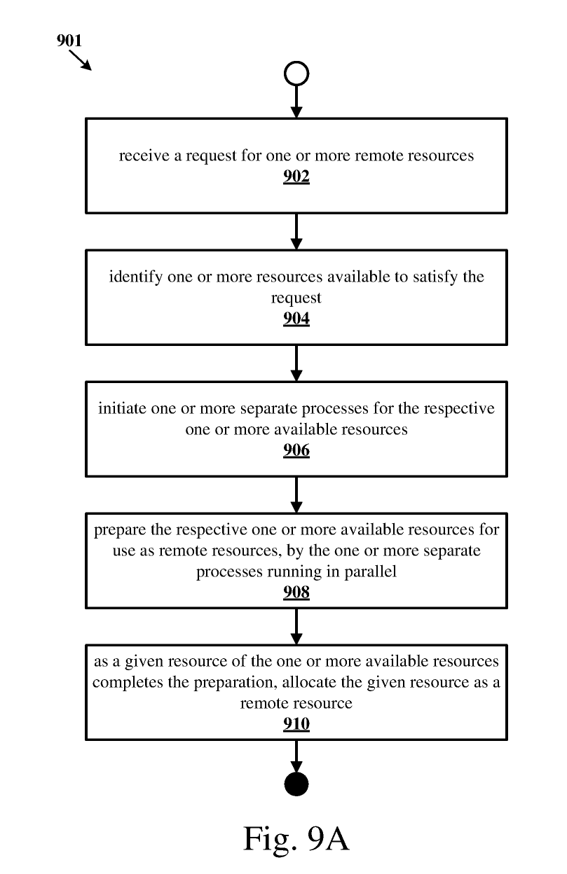

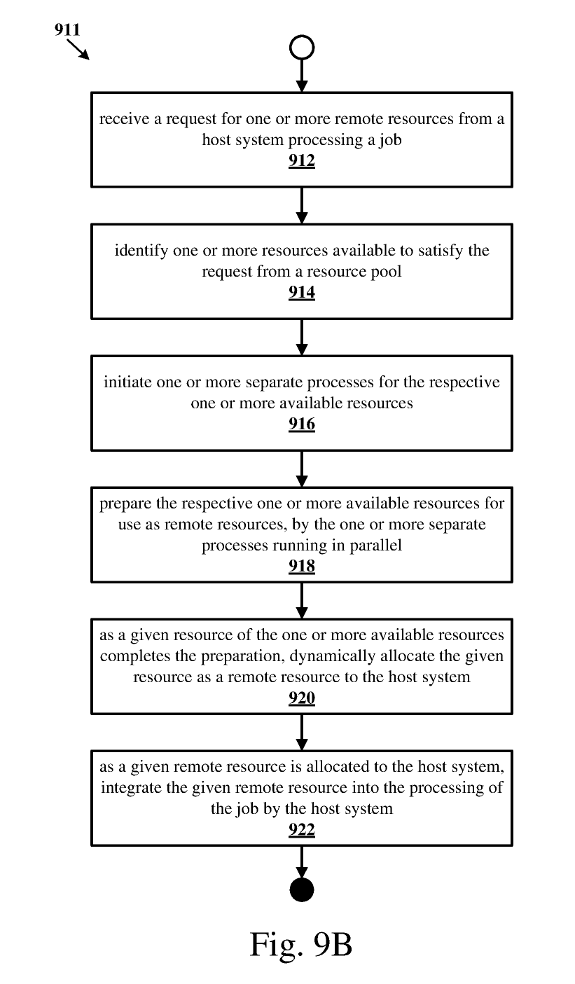

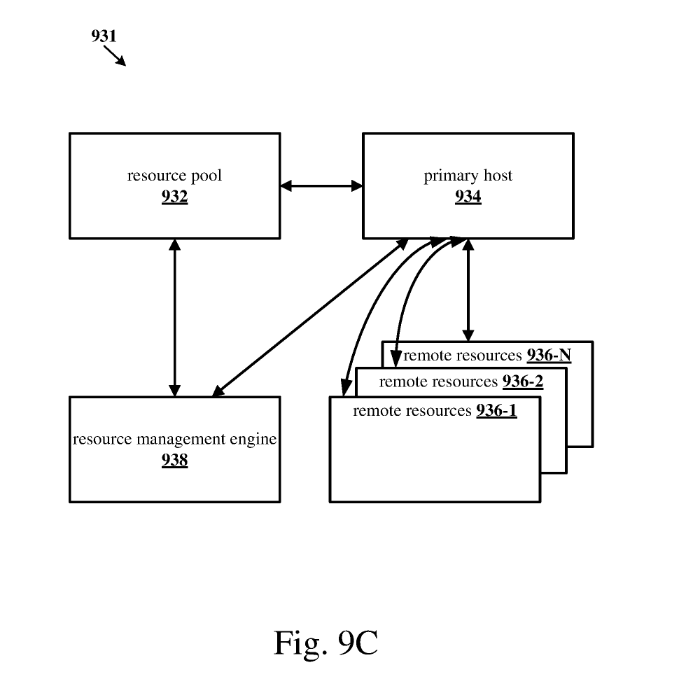

FIG. 9A depicts an example method 901 for dynamic remote resource allocation, as can be performed in certain examples of the disclosed technology. Any of the apparatus and systems disclosed herein can be used to implement the illustrated method.

At process block 902, a request is received for one or more remote resources.

At process block 904, one or more resources are identified to satisfy the request.

At process block 906, one or more separate processes are initiated for the respective one or more available resources.

At process block 908, the respective one or more available resources are prepared for use as remote resources, by the one or more separate processes running in parallel. Resources from the resource pool can then be verified, initialized, and allocated in parallel, as depicted in FIG. 5.

At process block 910, as a given resource of the one or more available resources completes the preparation, the given resource is allocated as a remote resource.

FIG. 9B depicts an example method 911 for dynamic remote resource allocation, as can be performed in certain examples of the disclosed technology. Any of the apparatus and systems disclosed herein can be used to implement the illustrated method.

At process block 912, a request is received for one or more remote resources from a host system processing a job.

At process block 914, one or more resources are identified to satisfy the request from a resource pool.

At process block 916, one or more separate processes are initiated for the respective one or more available resources.

At process block 918, the respective one or more available resources are prepared for use as remote resources, by the one or more separate processes running in parallel. Resources from the resource pool can then be verified, initialized, and allocated in parallel, as depicted in FIG. 5.

At process block 920, as a given resource of the one or more available resources completes the preparation, the given resource is dynamically allocated as a remote resource to the host system.

At process block 922, as a given resource is allocated to the host system, the given resource is integrated into the processing of the job by the host system.

FIG. 9C depicts an example system configuration 931 for dynamic remote resource allocation, as can be performed in certain examples of the disclosed technology. Any of the apparatus and systems disclosed herein can be used to implement the illustrated system.

According to one system configuration, a resource pool 932 can have available computing resources. A primary host 934 can coordinate processing of a job and can be coupled to the resource pool 932. One or more remote resources 936 can be coupled to the primary host 934 and can process separate portions of the job as coordinated by the primary host. A resource management engine 938 can be coupled to the resource pool 932 and the primary host 934. The resource management engine 938 can obtain computing resources from the resource pool 932, prepare the resources in parallel, and dynamically allocate the computing resources as part of the one or more remote resources 936-1 to 936-N coupled to the primary host 934 for use in processing the job while the primary host continues to coordinate processing of the job.

### Additional Aspects

At least certain examples of the disclosed technology can allow a distributed computing environment to continue processing a job without stopping the process to add resources for processing the job. This dynamic allocation of resources allows the distributed computing environment to scale up quickly to meet increased computational demand, or to scale down quickly when demand slackens and some resources are not needed. This leads to more efficient utilization of resources, allowing for optimization of licenses and hardware needed to complete processing. It also allows for processing to be completed faster as well as more efficiently.

The disclosed technologies can offer a flexible and robust approach to distributed resource management that enables remote CPU resource usage into the hundreds of thousands of remote compute system and remote data servers. Managing the remote resources in common allows for the dynamic allocation and robust distribution of resources. Having multiple remote registries lowers the registry access bottleneck locally at each host.

### Example Computing Systems

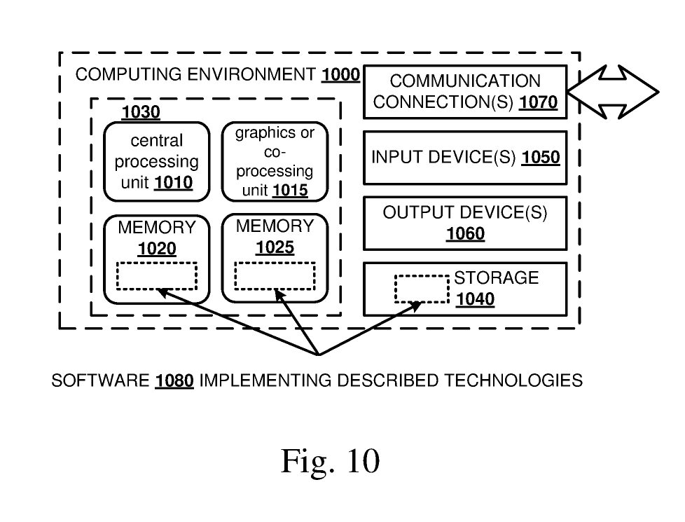

FIG. 10 depicts a generalized example of a suitable computing system 1000 in which the described innovations can be implemented. The computing system 1000 is not intended to suggest any limitation as to scope of use or functionality of the present disclosure, as the innovations can be implemented in diverse general-purpose or special-purpose computing systems.

With reference to FIG. 10, the computing system 1000 includes one or more processing units 1010, 1015 and memory 1020, 1025. In FIG. 10, this basic configuration 1030 is included within a dashed line. The processing units 1010, 1015 execute computer-executable instructions, such as for implementing components of the processes of 400, 500, or 600, or the architectures 100, 101, 102 of FIG. 1A-C, including the resource management engine 138, the primary host 132, etc., and other processes and architectures disclosed herein. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 10 shows a central processing unit 1010 as well as a graphics processing unit or co-processing unit 1015. The tangible memory 1020, 1025 can be volatile memory (e.g., registers, cache, RAM), non-volatile memory (e.g., ROM, EEPROM, flash memory, etc.), or some combination of the two, accessible by the processing unit(s) 1010, 1015. The memory 1020, 1025 stores software 1080 implementing one or more innovations described herein, in the form of computer-executable instructions suitable for execution by the processing unit(s) 1010, 1015. The memory 1020, 1025, can also store database data, such as data associated with the remote registry 139, 139a-c as shown in FIGS. 1A-C or the RDSs 323, 333, 343 as shown in FIG. 3.

A computing system 1000 can have additional features. For example, the computing system 1000 includes storage 1040, one or more input devices 1050, one or more output devices 1060, and one or more communication connections 1070. An interconnection mechanism (not shown) such as a bus, controller, or network interconnects the components of the computing system 1000. Typically, operating system software (not shown) provides an operating environment for other software executing in the computing system 1000, and coordinates activities of the components of the computing system 1000.

The tangible storage 1040 can be removable or non-removable, and includes magnetic disks, magnetic tapes or cassettes, CD-ROMs, DVDs, or any other medium which can be used to store information in a non-transitory way and which can be accessed within the computing system 1000. The storage 1040 stores instructions for the software 1080 implementing one or more innovations described herein.

The input device(s) 1050 can be a touch input device such as a keyboard, mouse, pen, or trackball, a voice input device, a scanning device, or another device that provides input to the computing system 1000. The output device(s) 1060 can be a display, printer, speaker, CD-writer, or another device that provides output from the computing system 1000.

The communication connection(s) 1070 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules or components include routines, programs, libraries, objects, classes, components, data structures, etc. that perform particular tasks or implement particular abstract data types. The functionality of the program modules can be combined or split between program modules as desired in various embodiments. Computer-executable instructions for program modules can be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example Cloud Computing Environment

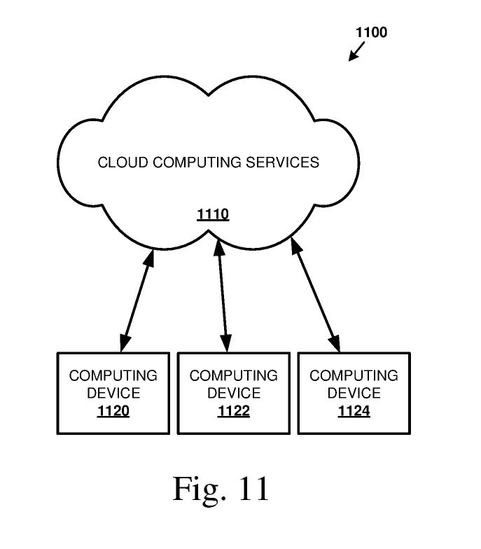

FIG. 11 depicts an example cloud computing environment 1100 in which the described technologies can be implemented. The cloud computing environment 1100 comprises cloud computing services 1110. The cloud computing services 1110 can comprise various types of cloud computing resources, such as computer servers, data storage repositories, networking resources, etc. The cloud computing services 1110 can be centrally located (e.g., provided by a data center of a business or organization) or distributed (e.g., provided by various computing resources located at different locations, such as different data centers and/or located in different cities or countries).

The cloud computing services 1110 are utilized by various types of computing devices (e.g., client computing devices), such as computing devices 1120, 1122, and 1124. For example, the computing devices (e.g., 1120, 1122, and 1124) can be computers (e.g., desktop or laptop computers), mobile devices (e.g., tablet computers or smart phones), or other types of computing devices. For example, the computing devices (e.g., 1120, 1122, and 1124) can utilize the cloud computing services 1110 to perform computing operations (e.g., data processing, data storage, and the like).

### Example Implementations

Although the operations of some of the disclosed methods are described in a particular, sequential order for convenient presentation, it should be understood that this manner of description encompasses rearrangement, unless a particular ordering is required by specific language set forth. For example, operations described sequentially can in some cases be rearranged or performed concurrently. Moreover, for the sake of simplicity, the attached figures cannot show the various ways in which the disclosed methods can be used in conjunction with other methods.

Any of the disclosed methods can be implemented as computer-executable instructions or a computer program product stored on one or more computer-readable storage media, such as tangible, non-transitory computer-readable storage media, and executed on a computing device (e.g., any available computing device, including smart phones or other mobile devices that include computing hardware). Tangible computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example, and with reference to FIG. 10, computer-readable storage media include memory 1020 and 1025, and storage 1040. The term computer-readable storage media does not include signals and carrier waves. In addition, the term computer-readable storage media does not include communication connections (e.g., 1070).

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Python, Ruby, ABAP, SQL, Adobe Flash, or any other suitable programming language, or, in some examples, markup languages such as html or XML, or combinations of suitable programming languages and markup languages. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology can be applied, it should be recognized that the illustrated embodiments are examples of the disclosed technology and should not be taken as a limitation on the scope of the disclosed technology. Rather, the scope of the disclosed technology includes what is covered by the scope of the following claims.

What is claimed is:

1. A method for dynamic remote resource allocation, the method comprising:
receiving a request for one or more remote resources;
identifying one or more resources available to satisfy the request;
initiating one or more separate processes for the respective one or more available resources;
preparing the respective one or more available resources for use as remote resources, by the one or more separate processes running in parallel; and
as a given resource of the one or more available resources completes the preparation, allocating the given resource as a remote resource.

2. The method of claim 1, wherein the request comprises a type of remote resources requested.

3. The method of claim 1, wherein allocating of the given resource is done in parallel to allocation of other requested resources as they become available.

4. The method of claim 1, wherein the request is made by a system processing a job in parallel to the request.

5. The method of claim 4, wherein allocating is done in parallel to the processing of the job.

6. The method of claim 4, wherein the allocated resources are dynamically integrated into the processing of the job.

7. The method of claim 4, further comprising:
as a given resource of the one or more available resources is allocated, tasking the given resource with a portion of the job for processing.

8. The method of claim 7, wherein the tasked resources process their respective portions of the job in parallel.

9. The method of claim 1, further comprising:
as a given resource of the one or more available resources is allocated, adding the given resource to a remote registry of allocated resources.

10. The method of claim 9, further comprising:
updating the remote registry to indicate an allocated resource is processing when the allocated resource is provided processing tasks.

11. The method of claim 9, further comprising:
releasing the allocated resource when it has completed the provided processing tasks.

12. The method of claim 1, further comprising:
monitoring the usage of the allocated resources.

13. One or more non-transitory computer-readable storage media storing computer-executable instructions for causing a computing system to perform a method of dynamic remote resource allocation, the method comprising:
receiving a request for one or more remote resources from a host system processing a job;
identifying one or more resources available to satisfy the request from a resource pool;
initiating one or more separate processes for the respective one or more available resources;
preparing the respective one or more available resources for use as remote resources, by the one or more separate processes running in parallel;
as a given resource of the one or more available resources completes the preparation, dynamically allocating the given resource as a remote resource to the host system; and
as a given remote resource is allocated to the host system, integrating the given remote resource into the processing of the job by the host system.

14. The one or more non-transitory computer-readable storage media of claim 13, wherein the remote resources are integrated into the processing of the job without stopping the processing.

15. The one or more non-transitory computer-readable storage media of claim 13, wherein the remote resources are integrated in parallel.

16. The one or more non-transitory computer-readable storage media of claim 13, wherein one or more remote resources allocated to the host system are further allocated to a secondary host system.

17. The one or more non-transitory computer-readable storage media of claim 16, wherein the one or more resources allocated to the secondary host system are integrated into the processing of a job by the secondary host system.

18. A system for distributed computing, comprising:
a resource pool, comprising computing resources available for use in processing a job;
a primary host, coupled to the resource pool, that coordinates processing of the job;
one or more remote resources, coupled to the primary host, that process separate portions of the job as provided by the primary host; and
a resource management engine, coupled to the resource pool and the primary host, that obtains computing resources from the resource pool, prepares the computing resources in parallel for use by the primary host as remote resources, and dynamically allocates the prepared resources to the primary host, such that the primary host can acquire the allocated resources while continuing to coordinate the processing of the job.

19. The system of claim 18, wherein the resource management engine is integrated with the primary host.

20. The system of claim 18, further comprising:
a remote registry, available to the primary host and the resource management engine, that is a register of remote resources allocated for use and the one or more remote resources coupled to the primary host, and comprises identification information for the remote resources.
